(19) United States
(12) Patent Application Publication
(10) Pub. No.: US 2005/0164610 A1
(43) Pub. Date: Jul. 28, 2005

(54) Chemical mechanical machining and surface finishing

(76) Inventors: Mark D. Michaud, Austin, TX (US); Gary Sroka, Missouri City, TX (US); Lane Winkelmann, New Ulm, TX (US)

Correspondence Address: Matthew F. Steinheider;Howrey Simon Arnold & White, LLP, 750 Bering Drive, Houston, TX, 77057, US

(21) Appl. No.: 11/012,518

(22) Filed: Dec. 15, 2004

Related U.S. Application Data
(63) Continuation of application No. 10/071,533, filed on Feb. 7, 2002.
(60) Provisional application No. 60/267,756, filed on Feb. 8, 2001.

(51) Int. Cl. B23C 1/00

(52) U.S. Cl. 451/47

(57) ABSTRACT

The invention described herein discloses a chemical mechanical machining and surface finishing process. A conversion coating is formed on the surface of a workpiece and is removed via relative motion with a tool, thereby exposing the workpiece to further reaction with the active chemistry. Low mechanical forces are used such that the plastic deformation, shear strength, tensile strength and/or thermal degradation temperature of the workpiece are not exceeded. Since the chemical mechanical machining and surface finishing process requires little force and/or speed of contact to remove the conversion coating, the equipment's mass, complexity and cost can be significantly reduced, while simultaneously increasing machining precision and accuracy. The present invention lends itself to a very controlled rate of metal removal, and can simply surface finish the workpiece, or if desired, can surface finish the workpiece simultaneously with the shaping and/or sizing process.

This application is a continuation of application Ser. No. 10/071,533, filed Feb. 7, 2002, which is a non-provisional application based on provisional application Ser. No. 60/267,756, filed Feb. 8, 2001.

### BACKGROUND OF THE INVENTION

Conventional mechanical machining is a highly aggressive process. No matter how much care and vigilance is taken, this process almost always results in metallurgical damage, if even only at the microscopic level, due to the application of highly concentrated forces and concomitant localized high temperature spikes. Such damage can include microcracks, the introduction of stress raisers, oxidation, phase change and a reduction in beneficial residual compressive stress and microhardness. The grinding process, for example, can generate sufficient heat to temper the surface of a hardened workpiece, often referred to as grinding burn, thus reducing the workpiece's wear and contact fatigue properties. In addition, conventional mechanical machining always produces burrs and machine lines. These residual burrs and machine lines are stress raisers that must be removed from critical surfaces in order to reduce wear, friction, operating temperature, scuffing, contact fatigue failure (pitting), and/or various dynamic fatigue failures such as bending, torsional and axial fatigue.

Besides metallurgical damage to the workpiece, conventional machining operations have an inherent limitation in producing workpieces with extremely high dimensional precision and accuracy. As mentioned previously, mechanical machining involves the aggressive shearing of metal from a workpiece by a tool that moves with a high speed and/or high force. Thus, tool wear is intrinsic to the process. Maintaining workpiece-to-workpiece dimensional precision and accuracy, however, relies on the ability to maintain dimensional stability of the tool. Tool wear becomes extremely problematic as the hardness of the workpiece increases to 40 HRC and greater. Gears and bearings, for example, are typically hardened to 55-65 HRC or higher.

The machine that guides the cutting tool has its own inherent set of limitations that inhibit high precision and accuracy. Some limitations of the mechanical devices moving the tool include geometric errors, feed rate errors, drive wear, vibration, and hysteresis, to name a few. The machines are usually massive in size so as to maintain the required rigidity to accurately apply the high forces that are necessary to remove metal especially from hard workpieces. Significant thermal distortions and structural deflections caused by the cutting load can also be problematic, especially for delicate workpieces.

In addition to machine lines, the forces applied to effect the aggressive cutting action of the tool also generate vibrations that lead to chatter. Chatter and machine lines are typically reduced by a multiple step process. For example, in the case of a high quality gear, the gear must be ground, and then honed to reduce the chatter and machine lines generated by machining. In the absence of extreme care, the grinding and honing processes can cause severe metallurgical damage to the critical contact surface of workpieces. Workpiece quality can only be ensured by costly 100% inspection.

The importance of a smooth surface finish cannot be overemphasized, particularly for metal-to-metal contact workpieces such as gears, bearings, splines, crankshafts, and camshafts, to name a few, that often have machine or grind lines or other surface imperfections that are very difficult to remove. For these workpieces, the asperities can increase friction, noise, vibration, wear, scuffing, pitting, spalling, operating temperature, and impair lubricity. For load-bearing articles, machine lines on the surface can provide an initiation point for fatigue fractures in workpieces that are subjected to fluctuating stresses and strains. As a result, there is a serious need to remove stress raisers caused by conventional machine lines.

One method of surface finishing such workpieces is to machine the surfaces by conventional multi-step, successively finer grinding, honing and lapping. Attaining a ground surface with a <2 microinch Rₐ requires time, multiple steps and state of the art technology. A complex surface geometry calls for expensive and highly sophisticated machinery, expensive tooling and time consuming maintenance. In addition to the cost, this process produces directional lines and the potential for tempering and microcracks that damage the integrity of the heat treated surface. As previously discussed, a quality workpiece requires costly 100% inspection of the ground and hardened surface with a technique such as nital etching. Another shortcoming of this approach is the possibility of abrasive particles being impregnated into the surface resulting in stress raisers, lubricant debris and/or wear.

### SUMMARY OF THE INVENTION

The invention described herein discloses a chemical mechanical machining and surface finishing process. An active chemistry is reacted with the surface of a workpiece so that a soft conversion coating is formed on the surface of a workpiece. The conversion coating is insoluble in the active chemistry in that it protects the basis metal of the workpiece from further chemical reaction with the active chemistry. The conversion coating is removed from the workpiece via relative motion with a contact tool, thereby exposing fresh metal for further reaction with the active chemistry, which allows the conversion coating to reform on the workpiece.

Low mechanical forces are used to remove the conversion coating from the workpiece, wherein the plastic deformation, shear strength, tensile strength and/or thermal degradation temperature of the basis metal of the workpiece are not exceeded. Thus, this chemical mechanical process eliminates the potential for tempering, microcracking, stress raisers and other metallurgical damage associated with conventional machining. Since the chemical mechanical machining and surface finishing process requires little force and/or speed of contact to remove the conversion coating, the equipment's mass, complexity and cost can be significantly reduced compared to conventional machining equipment while machining precision and accuracy can be increased. Tool wear is also minimal or eliminated due to the ability to operate at reduced cutting forces, speeds and operating temperatures. These reductions allow the tool to be fashioned from non-abrasive or slightly abrasive materials that are softer than the basis metal of the workpiece. The tool can be rigid or flexible such that it conforms to the surface of the workpiece.

In certain applications, machining equipment can be completely eliminated, wherein mating workpieces in relative motion and load act as the tools for the removal of the conversion coatings from their opposing contact surfaces. The present invention lends itself to a very controlled rate of metal removal, and can just surface finish the workpiece, or if desired, surface finish the workpiece simultaneously with the shaping and/or sizing of the workpiece. As used herein, “surface finishing” means to remove metal from the surface of a workpiece to reduce roughness, waviness, lays and flaws. “Sizing” means to uniformly remove metal from the surface of a workpiece to bring it to its proper dimension. “Shaping” means to differentially remove metal from a workpiece to bring it to its proper geometry. “Shaping” includes drilling, sawing, boring, cutting, milling, turning, grinding, planing, and the like.

### BRIEF DESCRIPTION OF THE DRAWINGS

FIG. 1 shows an example of a Falex Corporation FLC Lubricity Tester as used in examples 2 and 3.

FIG. 2 shows another example of a Falex Corporation FLC Lubricity Tester as used in examples 4 and 5.

### DETAILED DESCRIPTION OF THE INVENTION

In lieu of traditional cooling lubricants, the chemical mechanical machining and surface finishing process disclosed herein uses water-based or organic-based active chemistry capable of reacting with the surface of a metal workpiece, common metals being iron, titanium, nickel, chromium, cobalt, tungsten, uranium, and alloys thereof. The active chemistry is first introduced into the shaping, sizing and/or surface finishing machine so as to react with the basis metal of the workpiece to form a soft conversion coating. The conversion coating is insoluble in the active chemistry in that it protects the basis metal of the workpiece from further chemical reaction with the active chemistry. The conversion coating can comprise, for example, metal oxides, metal phosphates, metal oxalates, metal sulfates, metal sulfamates, or metal chromates.

The formation of the conversion coating is followed by appropriate tooling contact having a relative motion between the tool and the workpiece. The relative motion can be produced by movement of the tool across a stationary work piece, by movement of the workpiece across a stationary tool, or by movement of both the tool and the workpiece. The conversion coating is rubbed off by the tool, thereby exposing fresh metal on the workpiece, allowing for the re-formation of the conversion coating on the exposed metal. The metal removal rate is proportional to the rate of reaction of the active chemistry with the metal to form the conversion coating. This reaction rate can be increased by raising the temperature and by using chemical accelerants. As the reaction rate increases, the metal removal rate will be controlled by the rate of conversion coating removal. This process of rubbing and re-formation is repeated until such time as the desired surface finishing and/or shaping and/or sizing is achieved. No metallurgical damage occurs. The machining tool requires very little force to remove the conversion coating, and thus the machine's mass, complexity and cost can be significantly reduced as compared to conventional machining while machining precision and accuracy can be increased.

In the embodiments of the present invention, the relative motion and contact force of the tool and workpiece is less than the plastic deformation, shear strength and/or tensile strength of the workpiece such that thermal degradation temperatures are not produced on the workpiece. In some embodiments, the contact between the tool and the workpiece causes metal to be removed from the workpiece at a theoretical resolution of 1.0 microinch. Because of the small force applied to the workpiece from the tool, tool wear is minimized and/or eliminated. This chemical mechanical process lends itself to a very controlled rate of metal removal, and can surface finish the workpiece simultaneously with the shaping and/or sizing process.

When using this chemical mechanical machining and surface finishing process, a conversion coating is formed on the surface of the workpiece that is softer than the basis metal of the workpiece. Any active chemistry that can form such a chemical conversion coating on the surface of the workpiece is within the contemplation of the invention. Although the properties exhibited by the conversion coating produced on the basis metal are important to the successful practice of the present process, the formulation of the active chemistry is not. One such conversion coating is described in U.S. Pat. No. 4,818,333, assigned to REM Chemicals, Inc., the contents of which are herein incorporated by reference.

The active chemistry preferably is capable of quickly and effectively producing, under the conditions of operation, a soft conversion coating of the basis metal. The conversion coating must further be substantially insoluble in the active chemistry and protect the basis metal from further reaction so as to ensure that metal removal occurs primarily by rubbing and re-formation rather than by dissolution.

The active chemistry can also include activators, accelerators, oxidizing agents and, in some instances, inhibitors and/or a wetting agents. It should be noted that the amount of the added ingredients may exceed solubility limits without adverse effect. The presence of an insoluble fraction may be beneficial from the standpoint of maintaining a supply of active ingredients for replenishment of the active chemistry during the course of operations.

In more specific terms, depending upon the metal substrate involved, the active chemistry will typically comprise phosphate salts or phosphoric acid, oxalate salts or oxalic acid, sulfamate salts or sulfamic acid, sulfate salts or sulfuric acid, chromates or chromic acid, or mixtures thereof. In addition, known activators or accelerators may be added to the active chemistry such as, but not limited to, selenium, zinc, copper, manganese, magnesium and iron phosphates, as well as inorganic and organic oxidizers, such as but not limited to persulfates, peroxides, meta-nitrobenzenes, chlorates, chlorites, nitrates and nitrites.

The active chemistry used in this invention can be diluted or dispersed. The diluent or dispersant will most commonly be water, but can also be a material other than water such as, but not limited to, paraffinic oil, organic liquid, silicone oil, synthetic oil, other oils, greases, or lubricants. It is also anticipated that under certain conditions it might be preferable to create the conversion coating with highly concentrated acids such as sulfuric acid, methane sulfonic acid or phosphoric acid where water is a very minor component. Furthermore, an oil or lubricant can be used as the diluent or dispersant if desirable. This is desired when, for example, sulfuric acid is used with a mineral oil. Sulfuric acid is not appreciably soluble in mineral oils, but the mineral oil will act as a dispersant, as the sulfuric acid will be dispersed, instead of dissolved, throughout the mineral oil.

Any tool that can remove the soft conversion coating, previously described, to expose fresh metal without exceeding the plastic deformation, shear strength and/or tensile strength of the workpiece such that thermal degradation temperatures are not produced on the workpiece is within the contemplation of the invention. Although the properties of the tool are important to the successful practice of removing the conversion coating, the tool design is not. In some cases, the tool can be the mating surface of the workpiece or a facsimile thereof. For example, the workpiece can comprise a gear, and the tool can comprise a mating gear or facsimile thereof. In another example, the workpiece can comprise a bearing race, and the tool can comprise a plurality of mating bearing balls or rollers or facsimile thereof.

In accordance with the present invention, the tool can be either rigid or flexible. For example, if the workpiece is the root fillet of a gear, the tool can be a rigid, slightly abrasive cylinder sized such that it will contact all desired recessed areas to remove machine and/or grind lines and/or shot peening pattern. In another example, if the workpiece is the interior surface of a pipe or tube, a flexible and/or expandable tool that conforms to the workpiece can be used to improve the surface finish by removing forming lines or welding seams.

In one embodiment, the tool is not reactive with the active chemistry, in that the chemically induced conversion coating is not formed on the tool. Contemplated non-reactive materials that the tool can be made from are wood, paper, cloth, ceramic, plastic, polymer, elastomer, and metal, but any material that is not reactive with the active chemistry can be used. For instance, if the workpiece is a gear, the tool may be a non-reactive mating gear designed to impart the required shaping and/or surface finishing properties while running in mesh with the reactive workpiece.

There are a number of advantages of this chemical mechanical machining and surface finishing process. This process achieves a well-controlled metal removal rate capable of producing workpieces with high dimensional precision and accuracy. Metal can be removed with a resolution of approximately 1.0 microinch. This process also has the ability to simultaneously shape and/or size and/or surface finish, thereby reducing the gross number of processing steps. Since less force needs to be imparted to effect metal removal, a smaller, less complex and less expensive machine can be used to guide the tool. Tool speed is also much lower than that required in conventional machining, and tool costs and wear are significantly reduced.

Furthermore, much larger machining surface areas can be shaped and/or sized and/or surface finished at one time. This process also virtually eliminates burrs, machine lines, chatter, plastic deformation, and other surface deformities on the workpiece. A further advantage of the present process is a cool and burn-free machining process that causes little or no stress or metallurgical damage such as oxidation, phase change, stress raisers, and hardness changes. This process is usually carried out at or below the thermal degradation temperature of the metal. The low temperature also can help to eliminate the thermal deformation of delicate workpieces. In addition, structural deflections are minimized under the reduced tool pressure, which is especially important on delicate workpieces, minimizing and/or eliminating structural distortion and like deformities. Finally, the precision and accuracy of the machining process is tremendously improved.

In another embodiment of the present invention, in-situ shaping and/or sizing and/or surface finishing of metal-to-metal contact surfaces can be accomplished. This is done by adding active chemistry, with or without a fine abrasive, to the assembled apparatus so that a conversion coating is formed on the individual reactive metal surfaces of both the workpiece and the tool. Initially the apparatus can be operated under low load, which can be gradually increased to full load conditions. The conversion coating will be removed only at the critical contact surface where the rubbing, rolling, sliding, and the like occur to expose fresh metal for further reaction. Chemical mechanical machining and surface finishing will occur only at the critical contact surfaces to remove asperities that ultimately results in a line-free or nearly line-free surface. The process can be continued, if desired, to attain a superfinished surface and/or final shaping and/or sizing of mating workpieces to their ideal geometry. Thus, each mating surface will have an ideal matching contact surface area. The in-situ process can correct minor dimensional or geometrical errors in the mating components with highly controlled precision by adjusting the active chemistry characteristics, processing time and temperature, contact loading and contact speed.

In-situ surface finishing or superfinishing also has other advantages, such as making it possible to finish all of the critical contact surfaces of an entire assembly, such as a transmission, that significantly reduces the cost of finishing each individual workpiece. Once a process is optimized, the surface finishing is extremely reproducible, and can be accomplished easily in a factory environment, thus eliminating the need for 100% final inspection. The process can be carried out in or outside of the housing, and can concurrently final shape and/or size assembled mechanisms by removing minor dimensional/geometrical errors in the mating components. In gear and bearing applications, for example, this process reduces break-in periods, wear, scuffing, operating temperatures, friction, vibration and noise.

One embodiment of this in-situ process is two mating gears. The active chemistry can be introduced onto a first mating gear, forming a conversion coating on the first mating gear, while simultaneously forming a conversion coating on the second mating gear. The two mating gears are contacted with a relative motion therebetween that simultaneously removes the conversion coatings from the two gears. Thus, both gears are exposed to further reaction with the active chemistry such that the conversion coating is allowed to be re-formed and removed on the gears, until a desired surface property, such as surface finishing, shaping, sizing or combination thereof, of both gears is reached. In one embodiment, the gears are located within a transmission or gearbox, wherein the contact between the gears occurs during operation of the transmission or gearbox.

In another embodiment, a bearing race and a plurality of mating rolling elements are provided. The active chemistry is introduced onto the bearing race, simultaneously forming a conversion coating on the bearing race and the rolling elements. The bearing race and mating rolling elements are contacted with a relative motion therebetween that simultaneously removes the conversion coatings from the bearing race and the mating rolling elements. Thus, both the bearing race and the mating rolling elements are exposed to further reaction with the active chemistry such that the conversion coating is allowed to be re-formed and removed, until a desired surface property, such as surface finishing, shaping, sizing or combination thereof, of the bearing race and-mating rolling elements is reached.

### EXAMPLE 1

### In-Situ Surface Finishing

Two similar SAE 4140 carbon steel, 43-45 HRC, with nominal size of 3 inches by 1 inch by 12 inch were used as test samples. One ½ inch by 3-inch surface of each test sample was traditionally mechanically polished with 180 grit silicon carbide wet/dry paper in the longitudinal direction. The starting Rₐ and Rₘₐₓ of Coupon 1 were 10.0 μin. and 98.4 μin., respectively. The starting Rₐ and Rₘₐₓ of Coupon 2 were 17.6 μin. and 167 μin., respectively.

Coupon 2 was placed in a solution of 60 g/L oxalic acid and 20 g/L sodium metanitrobenzene sulfonate with its traditionally mechanically polished surface facing up. The traditionally mechanically polished surface of Coupon 1 was then placed in contact perpendicular to the traditionally mechanically polished surface of Coupon 2. Coupon 2 was held in a fixed position, and Coupon 1 was moved by hand in a back-and-forth and circular motion to simulate sliding motion of critical contact surfaces. Only very light pressure was applied. This was continued for approximately 10 minutes. The final Rₐ and Rₘₐₓ of Coupon 1 at the metal-to-metal contact surface were 1.71 μin. and 27.6 μin., respectively. The final Rₐ and Rₘₐₓ of Coupon 2 at the metal-to-metal contact surface were 1.95 μin. and 45.4 μin., respectively.

Example 1 shows that two mating workpieces fabricated from a hardened metal can be surface finished and even superfinished, and/or sized and/or shaped by wetting the surfaces with an appropriate active chemistry while lightly rubbing them together. No abrasives, high temperatures or high pressures are needed in this embodiment of the invention. The surface is shaped and/or sized and/or surface finished only where there is metal-to-metal contact.

When two or more gears are in mesh in a gearbox, their flanks can be shaped and/or surface finished in a similar fashion to that demonstrated in Example 1. This could be accomplished, for example, by turning the input shaft of the gearbox while applying a light load to the output shaft. The contact regions of the gear teeth would be wetted with the appropriate active chemistry either by continually flowing fresh active chemistry over the gear faces or by adding the active chemistry as a batch to the gearbox where the gears would be wetted with the active chemistry. With time the contact surfaces of the teeth will become smoother and the tooth profile will be shaped to the ideal gear geometry.

Similarly bearings can be shaped, sized and/or surface finished by the addition of active chemistry to the workpieces while running under very light loading. No metallurgical damage can occur as in conventional machining that uses abrasives or forces that generate high localized temperatures resulting in stress raisers or tempering leading to premature workpiece failure from friction, wear, scuffing, contact fatigue and dynamic fatigue.

The present invention is not limited to bearings or gears, but can be applied to any hard metal-to-metal contact that would benefit from surface finishing and/or sizing and/or shaping. The ability to shape and/or size and/or surface finish in one step increases the manufacturing efficiency for a variety of workpieces.

### EXAMPLE 2

### Traditional Mechanical Machining Baseline with Slightly Abrasive Tool

A Falex Corporation FLC Lubricity Test Ring, SAE 52100 steel, HRC 57-63, (part #001-502-001P), is traditionally mechanically machined using a slightly abrasive (600 grit) silicon carbide wet/dry paper and SAE 30 weight detergent free motor oil as a cooling lubricant.

A Falex Corporation FLC Lubricity Tester is used to rotate the ring at a set RPM while a hard plastic mold (Facsimile®) of the outer ring surface holds a piece of 600 grit silicon carbide wet/dry paper against it. The Falex supplied 0-150 foot-pound Sears Craftsman torque wrench with gravity acting on it is the only load applied to the traditional mechanical grinding process. The ring is partially submerged in a reservoir of SAE 30 weight detergent free motor oil throughout the test. FIG. 1 illustrates the test apparatus.

The test ring is cleaned, dried and weighed before and after processing on an analytical balance to determine metal removal.

The test ring has a weight of 22.0951 grams before processing. After a period of 1.0 hour of processing at 460 RPM the weight is 22.0934 grams. This is a loss of 0.0017 grams per hour that calculates to an 8.9 μin. change in dimension.

### EXAMPLE 3

### Chemical Mechanical Machining with Slightly Abrasive Tool

A Falex Corporation FLC Lubricity Test Ring, SAE 52100 steel, HRC 57-63, (part #001-502-001P), is chemically mechanically machined using a slightly abrasive (600 grit) silicon carbide wet/dry paper and FERROMIL® FML-575 IFP which is maintained at 6.25% by volume as the active chemistry to produce the conversion coating.

A Falex Corporation FLC Lubricity Tester is used to rotate the ring at a set RPM while a hard plastic mold (Facsimile®) of the outer ring surface holds a piece of 600 grit Silicon Carbide wet/dry paper against it. The Falex supplied 0-150 foot-pound Sears Craftsman torque wrench with gravity acting on it is the only load applied to the chemical mechanical process. The ring is partially submerged in FERROMIL® FML-575 IFP that is flowing through the reservoir at 6.5 milliliter/minute at ambient room temperature. See FIG. 1 for image of test apparatus.

The test ring is cleaned, dried and weighed before and after processing on an analytical balance to determine metal removal.

The test ring has a weight of 22.1827 grams before processing. After a period of 1.0 hour of processing at 460 RPM the weight is 22.1550 grams. This is a loss of 0.0277 grams per hour that calculates to a 145.6 μin. change in dimension. These results show that the metal removal rate is 16 times that of Example 2.

Examples 2 and 3 demonstrate that chemical mechanical machining on hard workpieces increases the rate of metal removal dramatically. Therefore, it is possible to shape and/or size and/or surface finish hardened metal workpieces using a slightly abrasive tool in conjunction with active chemistry. The hardness of the workpiece is inconsequential for as long as the active chemistry reacts with the surface. In fact, the rate of metal removal stays approximately the same no matter how high the hardness of the metal. In sharp contrast, in conventional machining (e.g., grinding, honing, polishing, etc.) as the workpiece's hardness increases to 60 HRC and higher, tool wear increases while metal removal rates decrease.

The embodiment of the invention of Examples 2 and 3 demonstrates that it is possible to shape and/or size and/or surface finish extremely hard metal surfaces using a slightly abrasive tool. This could be used, for example, to shape and/or surface finish the tooth profile of a gear. In this case, for example, a small rotating and/or vibrating tool with a light abrasive would be placed in contact with the gear flank of a gear that is continually wetted with an appropriate active chemistry. This would remove the machine and/or grind lines and be used to shape the tooth to the ideal gear geometry. This would significantly increase the service life of gears that experience bending fatigue, scuffing, and other failures while reducing gear noise and allowing for increased operating power densities.

The present invention is not limited to gears, but can be applied to any hard metal surface that would benefit from shaping and/or sizing and/or surface finishing. The ability to shape and surface finish in one step will increase the manufacturing efficiency of a variety of workpieces.

### EXAMPLE 4

### Traditional Mechanical Grinding Baseline with Non-Abrasive Plastic Tool

A Falex Corporation FLC Lubricity Test Ring, SAE 4620 steel, HRC 58-63, (part #S-25), is finished using REM® FBC-50 (soap mixture to prevent flash rusting and thermal degradation of the tool, but not capable of producing a conversion coating).

A Falex Corporation FLC Lubricity Tester is used to rotate the ring at a set RPM while a piece of fixtured FERROMIL® Media #NA (Pure plastic (polyester resin) without any abrasive particles) contacts the outer ring. The plastic media was shaped to the contour of the ring to provide adequate surface contact. The Falex supplied 0-150 foot-pound Sears Craftsman torque wrench with gravity acting on it is the only load applied to the traditional mechanical process. The ring is partially submerged in 1% by volume REM® FBC-50 that is flowing through the reservoir at 6.5 milliliter/minute. See FIG. 2 for image of test apparatus.

The test ring is cleaned, dried and weighed before and after processing on an analytical balance to determine metal removal.

The test ring has a weight of 22.3125 grams before processing. After a period of 3.0 hours at 460 RPM the weight is 22.3120 grams. This is a loss of 0.0005 grams total or 0.00017 grams per hour. Calculations show this to be a 0.9 μin. per hour change in dimension.

This example shows that an insignificant amount of metal is removed by the non-abrasive plastic on a hardened steel surface when no active chemistry is used.

### EXAMPLE 5

### Chemical Mechanical Machining with Non-Abrasive Plastic Tool

A Falex Corporation FLC Lubricity Test Ring, SAE 4620 steel, HRC 58-63, (part #S-25), is finished using FERROMIL® VII Aero-700.

A Falex Corporation FLC Lubricity Tester is used to rotate the ring at a set RPM while a piece of fixtured FERROMIL® Media #NA (Pure plastic (polyester resin) without any abrasive particles) contacts the outer ring. The plastic media was shaped to the contour of the ring to provide adequate surface contact. The Falex supplied 0-150 foot-pound Sears Craftsman torque wrench with gravity acting on it is the only load applied to the chemical mechanical machining process. The ring is partially submerged in FERROMIL® VII Aero-700 at 12.5% by volume that is flowing through the reservoir at 6.5 milliliter/minute. See FIG. 2 for image of test apparatus.

The test ring is cleaned, dried and weighed before and after processing on an analytical balance to determine metal removal.

The test ring has a weight of 22.1059 grams before processing. After a period of 3.0 hours at 460 RPM the weight is 22.0808 grams. This is a loss of 0.0251 grams total or 0.00837 grams per hour. Calculations show this to be a 44.0 μin. per hour change in dimension. This translates too more than 49 times the metal removal of Example 4 using non-abrasive tooling that is softer than the basis metal, and, thus, not capable of exceeding plastic deformation, shear strength or tensile strength of the basis metal.

Examples 4 and 5 demonstrate that significant amounts of metal can be removed from hardened steel even using a non-abrasive plastic. A tool fashioned from plastic then can be used to shape and/or size and/or surface finish a hardened steel surface when active chemistry is used. It is reasonable then that tools fashioned from harder materials will have greatly extended lives because they do not have to exert high forces or experience high localized temperatures. The tool will last longer since it can remove metal by exerting only the force needed to remove the soft conversion coating.

In addition, these two examples show that metal removal from very hard surfaces can be done with smaller machines than those used in conventional machining since less force needs to be exerted. The minimal structural deflections and lower temperatures under the reduced tool pressure, especially on delicate workpieces, will minimize and/or eliminate structural distortion and increase machining accuracy and precision. Since the metal removal rate is 44.0 μin. per hour, it is apparent that the machining can have an extremely high resolution of removing metal in increments of 1.0 μin.

### EXAMPLE 6

### Chemical Mechanical Surface Finishing

The root fillet area of a gear tooth was chemically mechanically surface finished to remove the axial grind lines. A tool was created by using a section of high-speed steel wire with a diameter of 0.067 in. wrapped with 600 grit wet/dry silicon carbide paper. The tool was rotated at approximately 80 RPM. The tool was held against the root fillet area of a gear tooth (Webster, AISI 8620 carburized steel, 17-tooth gear, 8-diametral pitch and 25° pressure angle, fillet radius of approximately 0.0469 inches) with very light pressure. A solution of 60 g/L oxalic acid and 20 g/L sodium metanitrobenzene sulfonate was introduced to the contact surface drop-wise (1-2 drops per 10 seconds). This was done for a period of 15 minutes. The silicon carbide paper was changed once after surface finishing for 10 minutes.

Examination of the surface finished workpiece at 10× magnification revealed that one or two axial grind lines remained with the majority of the surface being line free, smooth and flat. This shows that surface finishing can be executed on critical recessed surfaces using chemical mechanical surface finishing while maintaining very tight dimensional tolerances. Furthermore, machine and/or grind lines on the root fillet regions of gears can be removed by a relatively simple chemical mechanical surface finishing. Any lines created by using a light abrasive tool will be orthogonal to the axial grind lines. Therefore, tooth bending fatigue will be reduced significantly extending the gear's life.

The present invention is not limited to gears, but can be applied to any hard metal surface that experiences dynamic fatigue. The ability to shape and surface finish in one step will increase the manufacturing efficiency of a variety of workpieces.

While the apparatuses and methods of this invention have been described in terms of preferred embodiments, it will be apparent to those of skill in the art that variations may be applied to the process described herein without departing from the concept and scope of the invention. All such similar substitutes and modifications apparent to those skilled in the art are deemed to be within the scope and concept of the invention as it is set out in the following claims.

1. A process comprising:
a. providing a tool;
b. providing a metal workpiece having an Rₐ of 10.0 microinch or greater;
c. introducing an active chemistry onto the workpiece, the active chemistry being capable of reacting with the workpiece to form a conversion coating on the workpiece, the conversion coating being insoluble in the active chemistry such that the conversion coating protects the workpiece from further reaction, wherein the conversion coating causes no visible pitting or etching of the metal workpiece at 10× magnification;
d. contacting the tool with the workpiece with a relative motion therebetween, wherein the contact between the tool and the workpiece removes the conversion coating from the workpiece, thereby exposing the workpiece for further reaction with the active chemistry such that the conversion coating is allowed to re-form on the workpiece;
e. continuing said process until the workpiece has an Rₐ of less than 10.0 microinch.

2. The process of claim 1 wherein said process is continued until the workpiece has an Rₐ between 1.0 microinch and 5.0 microinch.

3. The process of claim 1 wherein said process is continued until the workpiece has an Rₐ of 1.0 to 3.0 microinch.

4. The process of claim 1 wherein said process is continued until the workpiece has an Rₐ of less than 2.0 microinch.

5. The process of claim 1, wherein the active chemistry is continuously introduced into the process.

6. The process of claim 1 wherein no abrasive material is used to remove basis metal from the metal workpiece.

7. The process of claim 1, further comprising using an abrasive material to remove the conversion coating from the workpiece.

8. The process of claim 1 wherein the force exerted by the tool on the workpiece causes no structural distortion of the workpiece.

9. The process of claim 1 wherein the tool is non-abrasive.

10. The process of claim 1 wherein the tool is slightly abrasive, such that the slightly abrasive tool is capable of removing the conversion coating without removing basis metal from the metal workpiece.

11. The process of claim 1 wherein the tool is rigid.

12. The process of claim 1 wherein the tool is flexible such that it conforms to the workpiece.

13. The process of claim 1 wherein the tool is a mating surface of the workpiece or a facsimile thereof.

14. The process of claim 1 wherein the tool is formed from a non-reactive material, such that a conversion coating is not formed on the tool.

15. The process of claim 14 wherein the non-reactive material is selected from the group consisting of wood, paper, cloth, ceramic, plastic, polymer, elastomer, and metal.

16. The process of claim 1 wherein the tool is reactive to the active chemistry such that a second conversion coating is formed on the tool.

17. The process of claim 1 wherein the workpiece comprises a gear and the tool comprises a mating gear or facsimile thereof.

18. The process of claim 1 wherein the workpiece comprises a bearing race and the tool comprises a plurality of mating bearing balls or rollers or facsimiles thereof.

19. The process of claim 1 wherein the workpiece and the tool are assembled in a housing.

20. The process of claim 1 wherein the workpiece comprises the root fillet of a gear, wherein the tool removes surface deformities from the root fillet of the gear, wherein the surface deformities are selected from the group consisting of machine lines, grind lines, shot peening patterns and combinations thereof.

21. The process of claim 1 wherein said process is controlled to remove stock from the workpiece with a resolution of 1.0 to 3.0 microinch per minute.

22. The process of claim 1 wherein the workpiece has a hardness of greater than HRC 43.

23. The process of claim 22, wherein the workpiece has a hardness of greater than HRC 57.

24. The process of claim 1 wherein the active chemistry comprises active ingredients selected from the group consisting of phosphate salts, phosphoric acid, oxalate salts, oxalic acid, sulfamate salts, sulfamic acid, sulfate salts, sulfuric acid, chromates or chromic acid, and mixtures thereof.

25. The process of claim 1 wherein the active chemistry is a concentrated acid.

26. The process of claim 25 wherein the concentrated acid is sulfuric acid.

27. The process of claim 1 wherein the active chemistry comprises activators or accelerators selected from the group consisting of selenium, zinc, copper, manganese, magnesium and iron phosphates.

28. The process of claim 1 wherein the active chemistry comprises inorganic or organic oxidizers selected from the group consisting of persulfates, peroxides, meta-nitrobenzenes, chlorates, chlorites, nitrates and nitrites and compounds thereof.

29. The process of claim 1 wherein the active chemistry is introduced onto the workpiece with a diluent or a dispersant.

30. The process of claim 29 wherein the diluent or dispersant is selected from the group consisting of water, organic liquids, paraffinic oils, silicone oils, synthetic oils, other oils, lubricants, greases, and combinations thereof.

31. The process of claim 1 wherein the conversion coating comprises a compound selected from the group consisting of an oxide of the workpiece metal, a phosphate of the workpiece metal, an oxalate of the workpiece metal, a sulfate of the workpiece metal, a sulfamate of the workpiece metal, and a chromate of the workpiece metal.

32. The process of claim 1 wherein the workpiece metal is selected from the group consisting of iron, titanium, nickel, chromium, cobalt, tungsten, uranium and alloys thereof.

33. A process comprising:
a. providing a tool;
b. introducing an active chemistry onto the workpiece, the active chemistry being capable of reacting with the workpiece to form a conversion coating on the workpiece, the conversion coating being insoluble in the active chemistry such that the conversion coating protects the workpiece from further reaction, wherein the conversion coating causes no visible pitting or etching of the metal workpiece at 10× magnification;
c. contacting the tool with the workpiece with a relative motion therebetween, wherein the contact between the tool and the workpiece removes the conversion coating from the workpiece, thereby exposing the workpiece for further reaction with the active chemistry such that the conversion coating is allowed to re-form on the workpiece;
d. continuing said process until a desired surface property of the workpiece is reached.

34. The process of claim 33 wherein the surface property of the workpiece is selected from the group consisting of surface finishing, shaping, sizing and combinations thereof.

35. The process of claim 33 wherein said process is controlled to remove stock from the workpiece with a resolution of 1.0 to 3.0 microinch per minute.

36. The process of claim 33 wherein the workpiece has a hardness of greater than HRC 43.

37. The process of claim 36, wherein the workpiece has a hardness of greater than HRC 57.

38. The process of claim 33, further comprising continuing the process until the workpiece has an Rₐ of less than 10.0 microinch.
